(19) United States
(12) Patent Application Publication
(10) Pub. No.: US 2004/0254916 A1
(43) Pub. Date: Dec. 16, 2004

(54) Data query schema based on conceptual context

(75) Inventors: Richard D. Dettinger, Rochester, MN (US); Frederick A. Kulack, Rochester, MN (US); Richard J. Stevens, Mantorville, MN (US); Eric W. Will, Oronoco, MN (US)

Correspondence Address: William J. McGinnis, Jr., IBM Corporation, Dept. 917, 3605 Highway 52 North, Rochester, MN, 55901-7829, US

(73) Assignee: INTERNATIONAL BUSINESS MACHINES CORPORATION, ARMONK, NY

(21) Appl. No.: 10/460,589

(22) Filed: Jun. 12, 2003

(51) Int. Cl. G06F 17/30

(52) U.S. Cl. 707/3

(57) ABSTRACT

Methods, articles of manufacture and systems for presenting, to a user, a limited subset of fields and associated values of an underlying base data model are provided. The limited subset of fields and associated values may be selected based on a relationship with one or more specified concepts, for example, of interest to a user. Thus, fields and associated values not related to the one or more specified concepts are filtered out (e.g., not available to the user). Through this conceptual filtering, the number of fields and values presented to the user may be significantly reduced, which may greatly simplify the query building process

### CROSS RELATED APPLICATIONS

The present invention is related to the commonly owned, co-pending U.S. patent application Ser. Nos. 10/083,075, entitled “Improved Application Portability And Extensibility Through Database Schema And Query Abstraction,” filed Feb. 26, 2002, and Ser. No. 10/401,293, entitled “Abstract Data Model Filters,” filed Mar. 27, 2003.

### BACKGROUND OF THE INVENTION

1. Field of the Invention

The present invention generally relates to data processing and more particularly to focusing the number of data model fields and values presented to a user during a query building process to those related to one or more specified concepts.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL). Illustratively, SQL is used to make interactive queries for getting information from and updating a database such as International Business Machines' (IBM) DB2, Microsoft's SQL Server, and database products from Oracle, Sybase, and Computer Associates. The term “query” denominates a set of commands for retrieving data from a stored database. Queries take the form of a command language that lets programmers and programs select, insert, update, find out the location of data, and so forth.

One of the issues faced by data mining and database query applications, in general, is their close relationship with a given database schema (e.g., a relational database schema). This relationship makes it difficult to support an application as changes are made to the corresponding underlying database schema. Further, the migration of the application to alternative underlying data representations is inhibited. In today's environment, the foregoing disadvantages are largely due to the reliance applications have on SQL, which presumes that a relational model is used to represent information being queried. Furthermore, a given SQL query is dependent upon a particular relational schema since specific database tables, columns and relationships are referenced within the SQL query representation. As a result of these limitations, a number of difficulties arise.

One difficulty is that changes in the underlying relational data model require changes to the SQL foundation that the corresponding application is built upon. Therefore, an application designer must either forgo changing the underlying data model to avoid application maintenance or must change the application to reflect changes in the underlying relational model. Another difficulty is that extending an application to work with multiple relational data models requires separate versions of the application to reflect the unique SQL requirements driven by each unique relational schema. Yet another difficulty is evolution of the application to work with alternate data representations because SQL is designed for use with relational systems. Extending the application to support alternative data representations, such as XML, requires rewriting the application's data management layer to use non-SQL data access methods.

A typical approach used to address the foregoing problems is software encapsulation. Software encapsulation involves using a software interface or component to encapsulate access methods to a particular underlying data representation. An example is found in the Enterprise JavaBean (EJB) specification that is a component of the Java 2 Enterprise Edition (J2EE) suite of technologies. In accordance with the EJB specification, entity beans serve to encapsulate a given set of data, exposing a set of Application Program Interfaces (APIs) that can be used to access this information. This is a highly specialized approach requiring the software to be written (in the form of new entity EJBs) whenever a new set of data is to be accessed or when a new pattern of data access is desired. The EJB model also requires a code update, application built and deployment cycle to react to reorganization of the underlying physical data model or to support alternative data representations. EJB programming also requires specialized skills, since more advanced Java programming techniques are involved. Accordingly, the EJB approach and other similar approaches are rather inflexible and costly to maintain for general-purpose query applications accessing an evolving physical data model.

Another shortcoming of the prior art, is the manner in which information can be presented to the user. A number of software solutions support the use of user-defined queries, in which the user is provided with a “query-building” tool to construct a query that meets the user's specific data selection requirements. In an SQL-based system, the user is given a list of underlying database tables and columns to choose from when building the query. The user must decide which tables and columns to access based on the naming convention used by the database administrator, which may be cryptic, at best.

Further, while the number of tables and columns presented to the user may be vast, only a limited subset may actually be of interest (e.g, be related to a user's particular field of research). Therefore, nonessential content is revealed to the end user, which may make it difficult to build a desired query, as the nonessential content must be filtered out by the user. In some cases, users who lack intimate knowledge of the content of the underlying database may not even realize what information is available to aid their research.

In other words, in a conventional data model, a single database schema encompasses all the data for an entity, although individual groups within the entity (teams, workgroups, departments, etc.) are typically only interested in a limited portion of the data. For example, in a medical research facility, a hemotology research group may only be interested in a limited number (e.g., 20-40) of medical tests, while an entity-wide data model may encompass thousands of tests. Accordingly, when building a query, members of the hemotology research group may spend a lot of effort just to filter through the large number of tests for which they have no interest.

Therefore, there is a need for an improved and more flexible method for presenting, to a user, a limited subset of all possible fields and associated values to choose from when building a query. Preferably, the limited subset of fields and associated values will only include those of interest to the user.

### SUMMARY OF THE INVENTION

The present invention generally provides methods, articles of manufacture and systems for presenting, to a user, a limited subset of all possible fields and associated values of a data model, for use when building a query.

One embodiment provides a method of providing access to data stored in a plurality of physical fields of a data repository. The method generally includes receiving a list of one or more concepts specified by a user, providing an interface allowing the user to build a database query based on a plurality of fields, and limiting fields presented to the user in the interface to those related to the one or more user-specified concepts.

Another embodiment provides a computer implemented method for generating a concept-specific data repository abstraction component describing, and used to access, data in a data repository. The computer implemented method generally includes selecting, from a base data repository abstraction component containing logical fields mapped to corresponding physical fields of the data repository, a subset of the logical fields contained in the base data repository abstraction component related to a specified one or more concepts and generating a first concept-specific data repository abstraction component containing the subset of the logical fields related to the one or more concepts.

Another embodiment provides a computer readable medium containing a program which, when executed, performs operations for generating a concept-specific data repository abstraction component describing, and used to access, data in a data repository. The operations generally include receiving, from a user, a list of one or more specified concepts, selecting, from a base data repository abstraction component containing logical fields mapped to corresponding physical fields of the data repository, a subset of the logical fields contained in the base data repository abstraction component related to the one or more concepts, and generating a first concept-specific data repository abstraction component containing the subset of the logical fields related to the one or more concepts.

Another embodiment provides a data processing system generally including a data repository, a base data abstraction component comprising logical fields mapped to corresponding physical fields of the data repository and an executable component. The executable component is generally configured to generate a first concept-specific data abstraction component comprising a limited subset of the logical fields of the base data abstraction component related to a first one or more specified concepts.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the present invention.

FIG. 2A is a relational view of software components, including a concept-specific data repository abstraction component, according to one embodiment of the present invention.

FIGS. 2B, 2C, and 2D illustrate an exemplary base data repository abstraction component, an exemplary concept-specific filter, and an exemplary concept-specific data repository abstraction component, respectively, according to one embodiment of the present invention.

FIG. 3 is a flow chart illustrating exemplary operations for generating a concept-specific data repository abstraction component according to aspects of the present invention.

FIG. 4 illustrates the generation and use of concept-specific data repository abstraction components according to one embodiment of the present invention.

FIGS. 5A-5E illustrate exemplary graphical user interface (GUI) screens according to one embodiment of the present invention.

### DETAILED DESCRIPTION OF THE PREFERRED EMBODIMENTS

The present invention generally is directed to methods, articles of manufacture and systems for presenting, to a user, a limited subset of fields and associated values of an underlying base data model. The limited subset of fields and associated values may be selected based on a relationship with one or more specified concepts, for example, of interest to a user. Thus, specifying the concepts of interest may be regarded as analogous to applying one or more filters to select or exclude the fields and associated values of the base data model. Through this conceptual filtering, the number of fields and values presented to the user may be significantly reduced, which may greatly simplify the query building process.

In one embodiment of the present invention, the data model is implemented as a data repository abstraction (DRA) component containing a collection of abstract representations of physical fields of the database (hereinafter “logical fields”). Thus, this data abstraction model provides a logical view of the underlying database, allowing the user to generate “abstract” queries against the data warehouse without requiring direct knowledge of its underlying physical properties. A runtime component (e.g., a query execution component) performs translation of abstract queries (generated based on the data abstraction model) into a form that can be used against a particular physical data representation.

The concepts of data abstraction and abstract queries are described in detail in the commonly owned, co-pending application Ser. No. 10/083,075, entitled “Improved Application Portability And Extensibility Through Database Schema And Query Abstraction,” filed Feb. 26, 2002, herein incorporated by reference in its entirety. While the data abstraction model described herein provides one or more embodiments of the invention, persons skilled in the art will recognize that the concepts provided herein can be implemented without such a data abstraction model while still providing the same or similar results.

### Exemplary Application Environment

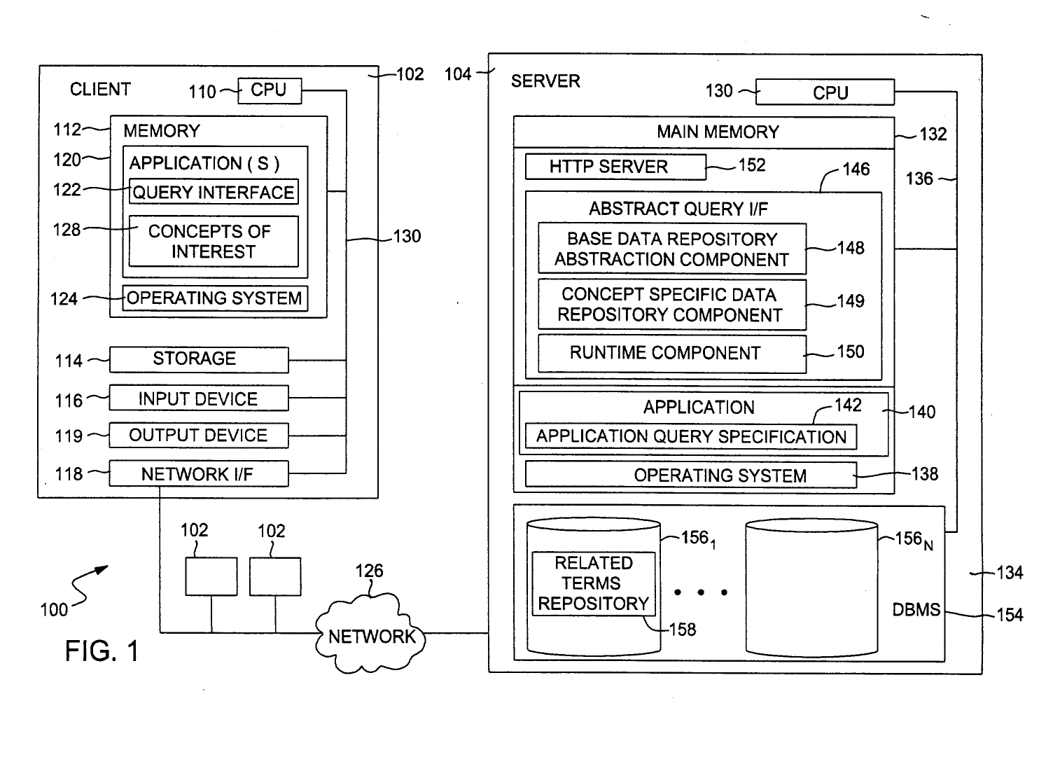

FIG. 1 shows an exemplary networked computer system 100, in which embodiments of the present invention may be utilized. For example, embodiments of the present invention may be implemented as a program product for use with the system 100, to generate a concept-specific data repository abstraction (DRA) component 149 including fields and associated values related to one or more concepts of interest 128. The concept-specific DRA component 149 may present a user (e.g., a user of an application 120 running on a client computer 102) with a limited subset of fields from the base DRA component 148 in order to access data from the one or more databases 156_{1 . . . N}.

The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

As illustrated in FIG. 1, the system 100 generally includes client computers 102 and at least one server computer 104, connected via a network 126. In general, the network 126 may be a local area network (LAN) and/or a wide area network (WAN). In a particular embodiment, the network 126 is the Internet.

As illustrated, the client computers 102 generally include a Central Processing Unit (CPU) 110 connected via a bus 130 to a memory 112, storage 114, an input device 116, an output device 119, and a network interface device 118. The input device 116 can be any device to give input to the client computer 102. For example, a keyboard, keypad, light-pen, touch-screen, track-ball, or speech recognition unit, audio/video player, and the like could be used. The output device 119 can be any device to give output to the user, e.g., any conventional display screen. Although shown separately from the input device 116, the output device 119 and input device 116 could be combined. For example, a client 102 may include a display screen with an integrated touch-screen or a display with an integrated keyboard.

The network interface device 118 may be any entry/exit device configured to allow network communications between the client 102 and the server 104 via the network 126. For example, the network interface device 118 may be a network adapter or other network interface card (NIC). If the client 102 is a handheld device, such as a personal digital assistant (PDA), the network interface device 118 may comprise any suitable wireless interface to provide a wireless connection to the network 126.

Storage 114 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory (RAM) sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips.

Illustratively, the memory 112 contains an operating system 124. Examples of suitable operating systems, which may be used to advantage, include Linux and Microsoft's Windows®, as well as any operating systems designed for handheld devices, such as Palm OS®, Windows® CE, and the like. More generally, any operating system supporting the functions disclosed herein may be used.

The memory 112 is also shown containing a query building interface 122, such as a browser program, that, when executed on CPU 110, provides support for building queries based on the data repository abstraction component 148. In one embodiment, the query interface 122 includes a web-based Graphical User Interface (GUI), which allows the user to display Hyper Text Markup Language (HTML) information. More generally, however, the query interface 122 may be any program (preferably GUI-based) capable of exposing a portion of the DRA component 148 on the client 102 for use in building queries. As will be described in greater detail below, queries built using the query interface 122 may be sent to the server 104 via the network 126 to be issued against one or more databases 156.

The server 104 may be physically arranged in a manner similar to the client computer 102. Accordingly, the server 104 is shown generally comprising a CPU 130, a memory 132, and a storage device 134, coupled to one another by a bus 136. Memory 132 may be a random access memory sufficiently large to hold the necessary programming and data structures that are located on the server 104.

The server 104 is generally under the control of an operating system 138 shown residing in memory 132. Examples of the operating system 138 include IBM OS/400®, UNIX, Microsoft Windows®, and the like. More generally, any operating system capable of supporting the functions described herein may be used. As illustrated, the server 104 may be configured with an abstract query interface 146 for issuing abstract queries (e.g., received from the client application 120) against one or more of the databases 156.

In one embodiment, elements of a query are specified by a user through the query building interface 122 which may be implemented as a browser program presenting a set of GUI screens for building queries. The content of the GUI screens may be generated by application(s) 140. In a particular embodiment, the GUI content is hypertext markup language (HTML) content which may be rendered on the client computer systems 102 with the query building interface 122. Accordingly, the memory 132 may include a Hypertext Transfer Protocol (http) server process 138 (e.g., a web server) adapted to service requests from the client computer 102. For example, the server process 152 may respond to requests to access the database(s) 156, which illustratively resides on the server 104. Incoming client requests for data from a database 156 invoke an application 140 which, when executed by the processor 130, perform operations necessary to access the database(s) 156. In one embodiment, the application 140 comprises a plurality of servlets configured to build GUI elements, which are then rendered by the query interface 122.

Referring back to the client 102, the memory 112 may also contain one or more concepts of interest 128, for example, specified by a user of the application 120. The concepts of interest 128 may be accessed to determine which fields and associated values to select from the base DRA component 148 in order to create a concept-specific DRA component 149 containing subset of fields and associated values tailored to the particular needs of an application 120 or a user thereof. For example, as previously described, the applications 120 may be used by different groups (departments, workgroups, etc.) within the same entity to query the databases 156 represented by the base DRA component 148, although each group may only be interested in a limited portion of data stored therein. Accordingly, in an effort to limit the number of logical fields and associated values presented to users of each group, each group may specify a different set of concepts 128, to generate a concept-specific DRA component 149 containing only those fields and associated values of interest to that group.

For some embodiments, concepts of interest may be supplemented by related concepts, based on a related terms repository 158. The related terms repository 158 may act, in effect, as a thesaurus during generation of the concept-specific DRA component 149, in an effort to ensure related fields and values are not excluded due to use of different term. For example, the related terms repository 158 may be used to relate concepts associated with generally synonymous terms (e.g., “heart disease,” “coronary,” “cardiac,” and the like), in an effort to ensure certain fields and/or values of interest are not excluded merely by the user's choice of descriptive terms for the concept.

### An Exemplary Runtime Environment

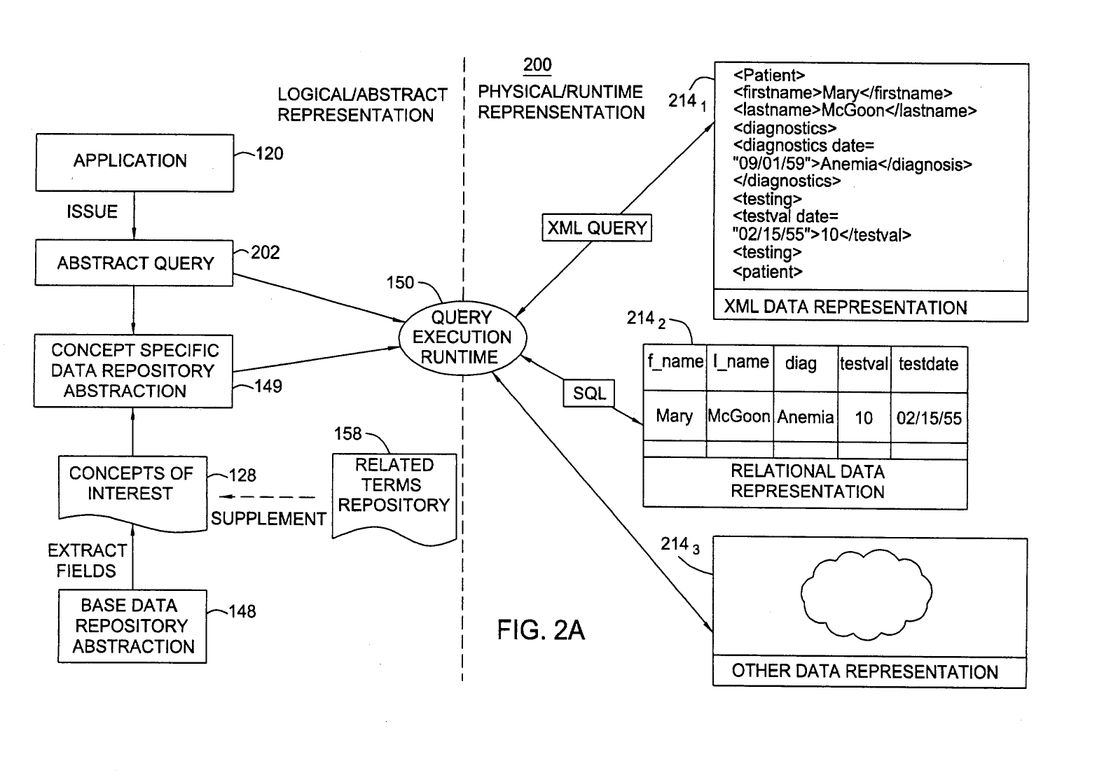

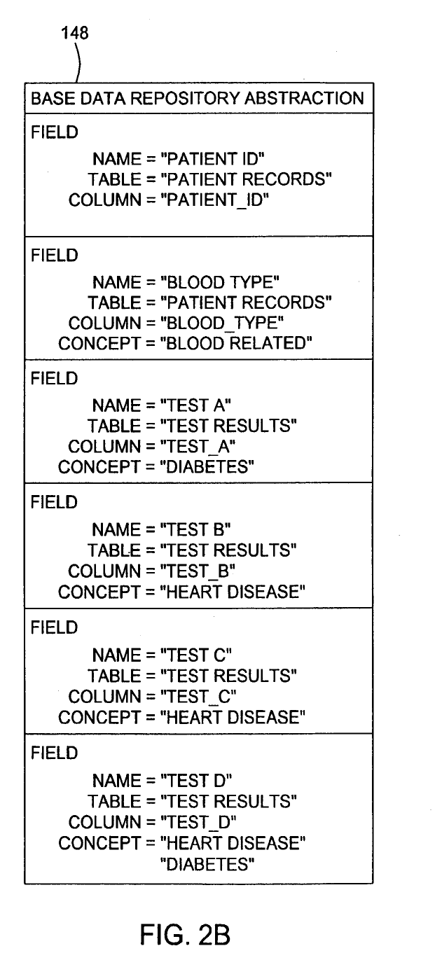

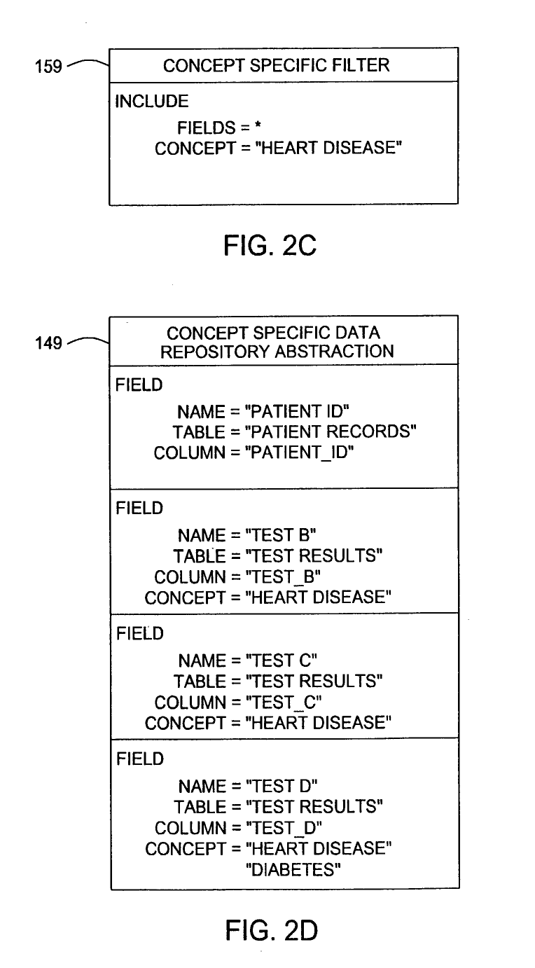

Before describing generation of the concept-specific DRA component 149 in detail, however, operation of the various illustrated components of the abstract query interface 146 will be described with reference to FIGS. 2A-2D. FIG. 2A illustrates a relational view of a client application 120, DRA component 148, concept-specific DRA component 149, and query execution component 150, according to one embodiment of the invention. As shown, the application 120 may issue an abstract query 202, which may be executed by the query execution component 150. The abstract query 202 may be generated by specifying query conditions (criteria) and results involving logical fields contained in the concept-specific DRA component 149.

An illustrative abstract query corresponding to the abstract query 202 is shown in Table I below. By way of illustration, the abstract query 202 is defined using XML. However, any other language may be used to advantage.

TABLE I
QUERY EXAMPLE

| | |
|---|---|
| 001 | <?xml version=“1.0”?> |
| 002 | <!--Query string representation: (FirstName = “Mary” AND |
| | LastName = |
| 003 | “McGoon”) OR State = “NC”--> |
| 004 | <QueryAbstraction> |
| 005 | <Selection> |
| 006 | <Condition internalID=“4”> |
| 007 | <Condition field=“FirstName” operator=“EQ” |
| | value=“Mary” |
| 008 | internalID=“1”/> |
| 009 | <Condition field=“LastName” operator=“EQ” |
| | value=“McGoon” |
| 010 | internalID=“3” relOperator=“AND”></Condition> |
| 011 | </Condition> |
| 012 | <Condition field=“City” operator=“EQ” value=“NC” |
| | internalID=“2” |
| 013 | relOperator=“OR”></Condition> |
| 014 | </Selection> |
| 015 | <Results> |
| 016 | <Field name=“FirstName”/> |
| 017 | <Field name=“LastName”/> |
| 018 | <Field name=“ City ”/> |
| 019 | </Results> |
| 020 | </QueryAbstraction> |

Illustratively, the abstract query shown in Table I includes a selection specification (lines 005-014) containing selection criteria and a results specification (lines 015-019). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

The logical fields presented to a user of the application 120 and used to compose the abstract query 202 are defined by the concept-specific DRA component 149, which includes logical fields and associated values extracted from the base DRA component 148 and related to the specified concepts of interest 128 (which may be supplemented with related concepts, based on the related terms repository 158). As previously described, in the exemplary abstract data model, the logical fields are defined independently of the underlying data representation being used in the DBMS 154, thereby allowing queries to be formed that are loosely coupled to the underlying data representation. For example, as illustrated in FIG. 2B, the DRA component 148 includes a set of logical field specifications 208 that provide abstract representations of corresponding fields in a physical data representation 214 of data in the one or more databases 156 shown in FIG. 1.

Each logical field specification 208 may include various information used to map the specified logical field to the corresponding physical field, such as field names, table names, and access methods (not shown) describing how to access and/or manipulate data from the corresponding physical field in the physical data representation 214. The physical data representation may be an XML data representation 214₁, a relational data representation 214₂, or any other data representation, as illustrated by 214_{N}. Therefore, regardless of the actual physical data representation, a user may generate, via the query building interface 122 (shown in FIG. 1) of the client application 120, an abstract query 202 including query conditions based on the logical fields defined by the logical field specifications 208, in order to access data stored therein.

Referring back to FIG. 2A, the query execution component 150 is generally configured to execute the abstract query 202 by transforming the abstract query 202 into a concrete query compatible with the physical data representation (e.g., an XML query, SQL query, etc). The query execution component 150 may transform the abstract query 202 into the concrete query by mapping the logical fields of the abstract query 202 to the corresponding physical fields of the physical data representation 214, based on mapping information in the concept-specific DRA component 149. The mapping of abstract queries to concrete queries, by the query execution component 150, is described in detail in the previously referenced co-pending application Ser. No. 10/083,075.

The terms that may be included in the specified concepts of interest 128 (as well as related terms in the related term repository 158) may be regarded as keywords for each entity (e.g., category, field, or associated value) that establish one or more base concepts associated with the entity. A number of different techniques may be employed to identify and select, from the base DRA component 148, logical fields and associated values associated with the specified concepts of interest 128, based on these conceptual terms.

For example, for some embodiments, the relationship of fields and associated values with certain concepts may be derived by examining category names, fields names, field descriptions, and value lists associated with fields (commonly accessible as metadata). For example, such data may be searched for matches with text used in the concepts (and synonyms, as defined by the related terms repository 158) and fields or categories with names and/or associated values containing matching text may be included in the concept-specific DRA component 149.

As an alternative, the concepts to which an entity relate may be explicitly defined as part of the abstract data model itself. For example, as illustrated in FIG. 2B, the logical specifications 208 for some of the logical fields in the base DRA component 148 may include a Concept Attribute that explicitly lists one or more concepts to which the logical field relates (associated values, while not shown, may also have a Concept Attribute). Thus, any type mechanism may be utilized to identify fields and associated values related to a specified concept of interest 128 by examining this attribute.

For example, as illustrated in FIG. 2C, a concept specific filter 159 may be generated that, when applied to the base DRA component 148, selects entities related to a concept listed therein. The concepts abstract data model filters are described in detail in the commonly-owned commonly owned, co-pending application Ser. No. 10/401,293, entitled “Abstract Data Model Filters,” filed Mar. 27, 2003 herein incorporated by reference. For some embodiments, the filter 159 may specify a name of fields to include or, as shown in FIG. 2C, a wildcard value (*) may also be used to specify any fields having the specified concept should be included in the concept-specific DRA component 149.

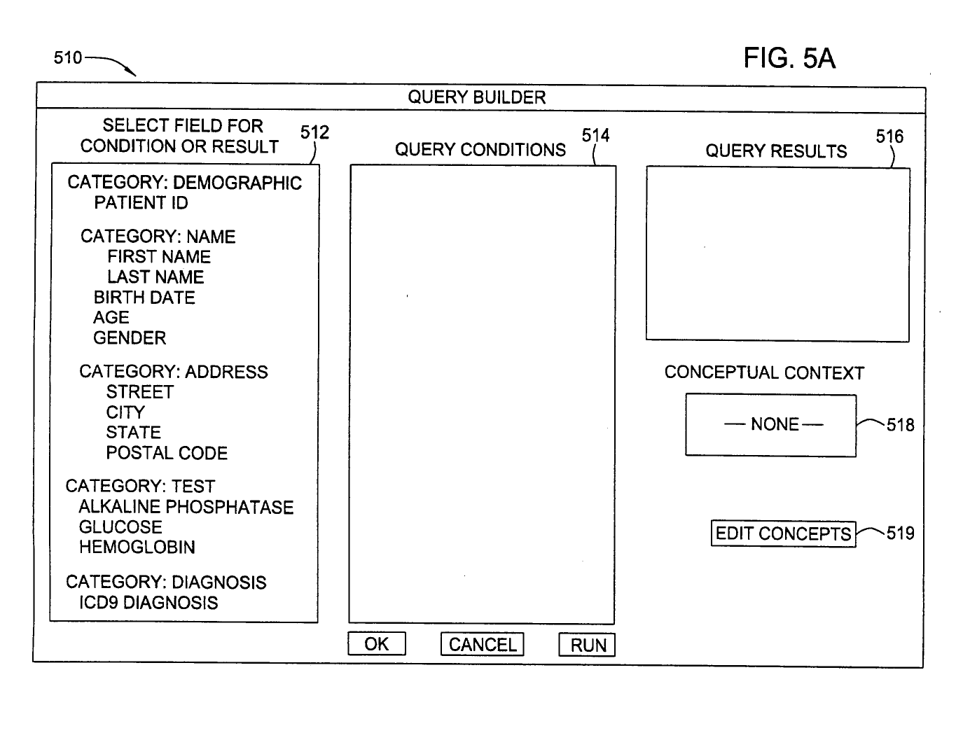

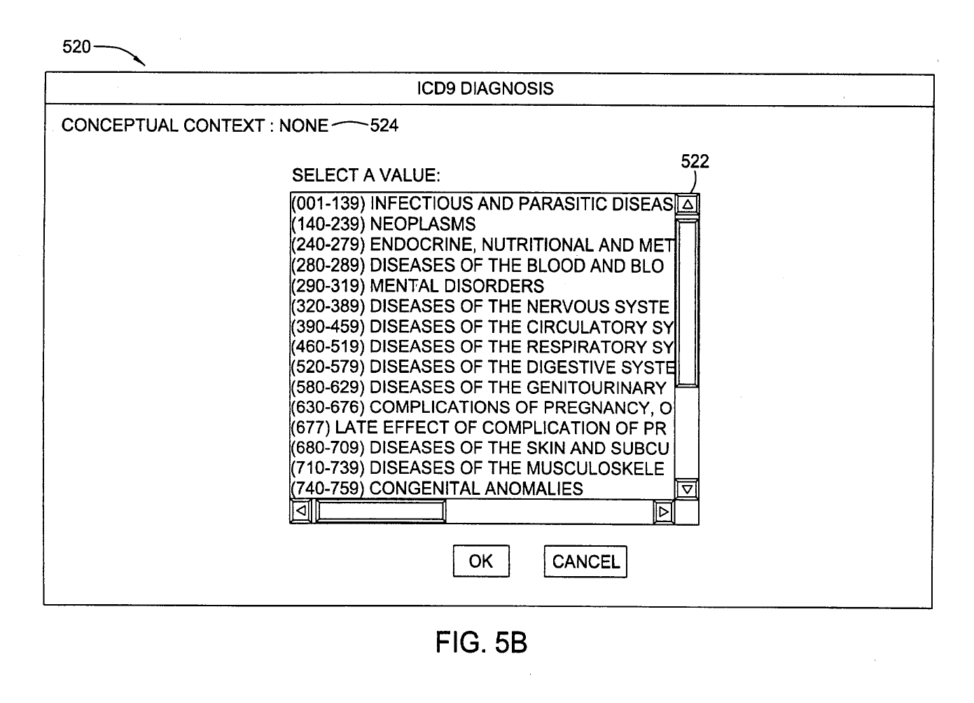

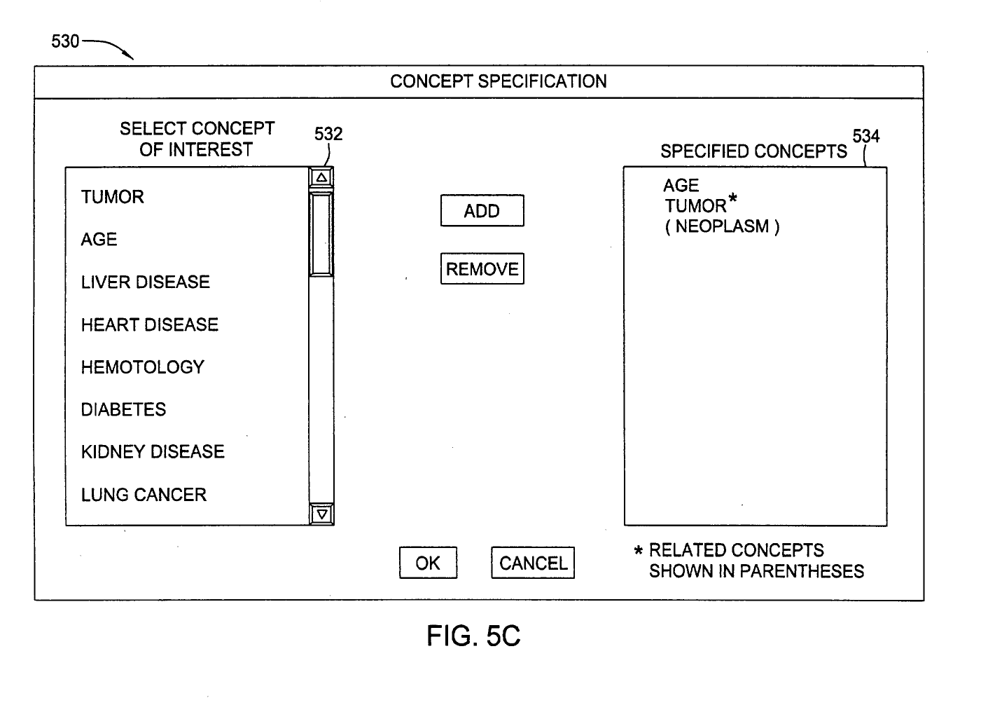

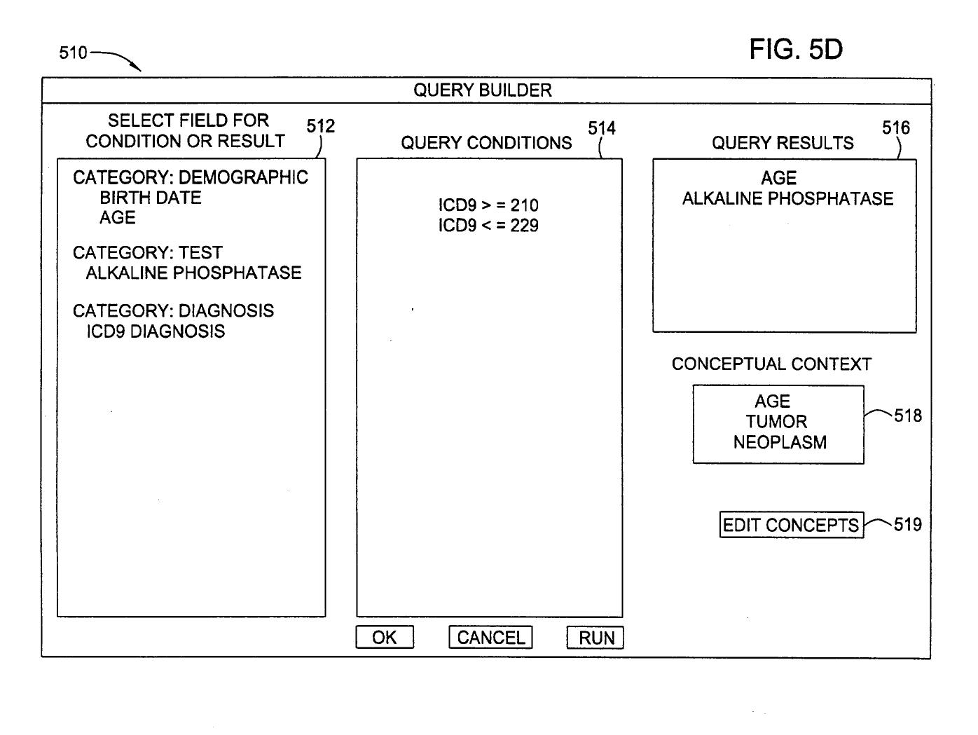

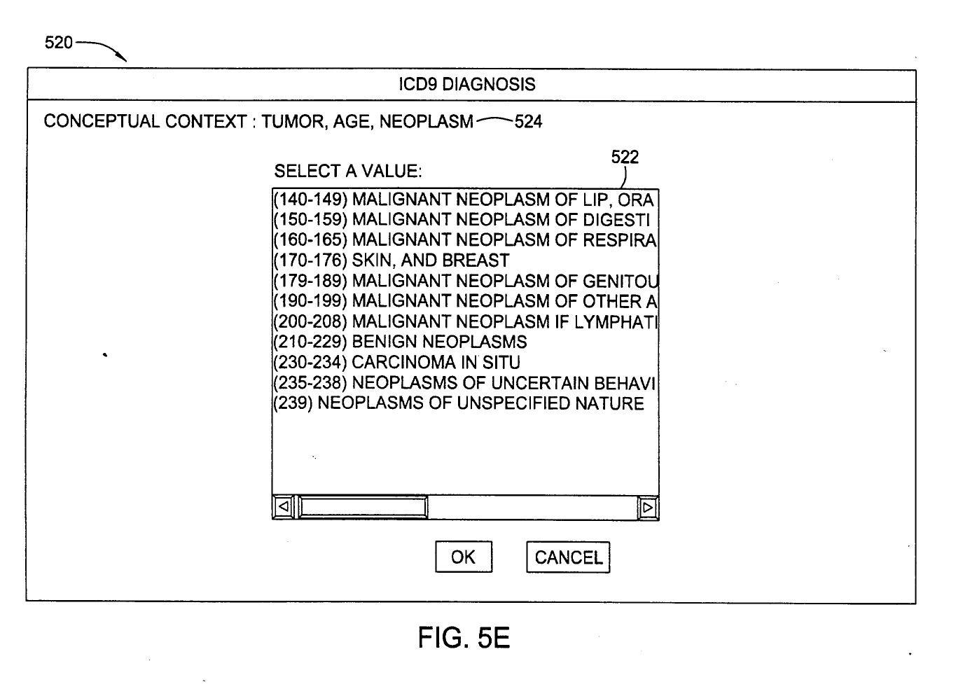

As an illustration, the filter 159 of FIG. 2C may be applied to the DRA component 148 of FIG. 2B, to select a limited subset of the logical field specifications 208 contained therein, in order to generate the concept-specific DRA component 149 (conceptually scoped to heart disease) illustrated in FIG. 2D. As illustrated, the filter 159 selects logical fields 208₁, 208₄, 208₅, and 208₆ (related to heart disease) from the DRA component 148 for inclusion in the concept-specific DRA component 149. As be described below with reference to FIGS. 5A-5E, associated values for the selected fields may be conceptually filtered in a similar manner. For some embodiments, logical fields 208 may be organized in individual categories, which may have their own concept attributes or may “inherit” the concept attributes of fields and associated values contained therein. For example, depending on the implementation an entire category of fields may be included in the concept-specific DRA component 149 if any of the fields contained therein is related to a specified concept (e.g., based on an assumed relationship by being in the same category) or only those fields related to the specified concept may be included.

### Generating a Conceptually Scoped Data Model

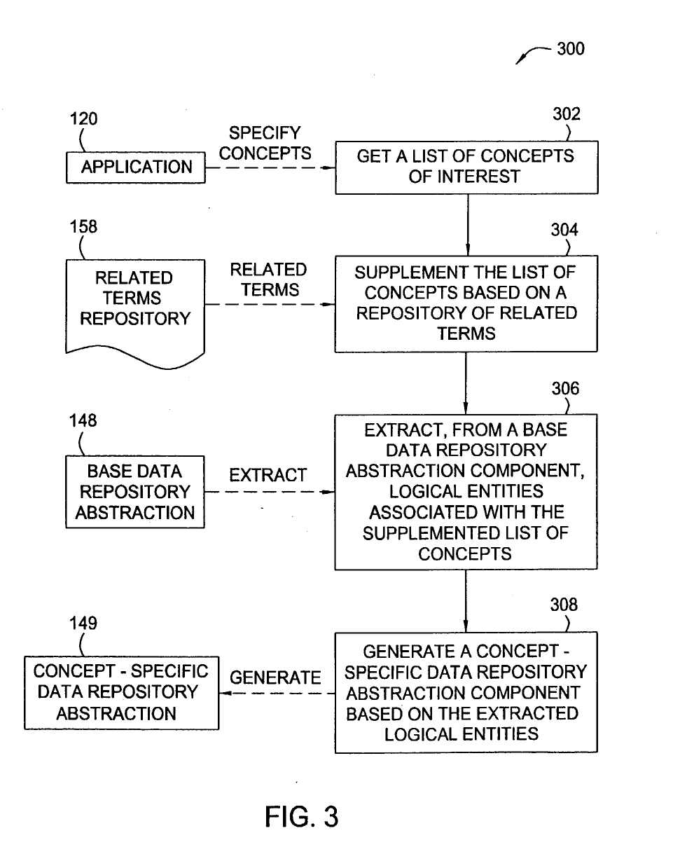

FIG. 3 is a flow diagram of operations 300 for conceptual filtering that may be performed, for example, by a component of the abstract interface 146 (e.g., the runtime component) or the application program 120 (e.g., the query building interface 122). The operations 300 may be described with reference to FIGS. 2A-2D and may be performed, for example, in preparation of, or as part of, a query building process. For some embodiments, the operations 300 may also be periodically performed (e.g., automatically) to dynamically update the types of fields and associated values presented to a user, for example, as new data is obtained (e.g., new types of tests related to a specified concept of interest). Further, new knowledge may be gained about relationships of a (previously unrelated) field to a specified concept (e.g., new research may show a certain result of a known test is a precursor to a certain disease), for example, resulting in the Concept Attribute for that field being update to reflect the relationship.

In either case, the operations 300 begin at step 302, by receiving a list of concepts of interest, for example specified by a user of the application 120. At step 304, the list of concepts is (optionally) supplemented based on a repository of related terms/concepts, or similar such data. For example, the original list of specified concepts may include a “heart disease” concept, which may be supplemented, based on the related term “coronary” to include other concepts. At step 306, logical entities (e.g., fields and/or values) associated with the supplemented list of concepts is extracted from the base DRA component 148. At step 308, a concept-specific DRA component 149 is generated, based on the extracted logical entities.

Of course, the particular operations 300 are for illustrative purposes only, and may be modified in various ways. For example, for some embodiments, rather than actually generate a concept-specific DRA component 149, the fields presented to a user may be otherwise limited every time a query building GUI screen (such as those shown in FIGS. 5A-5E) is drawn. Further, while the operations 300 are specific to an abstract data model, similar operations may be performed to limit the fields presented to a user working within a conventional data model.

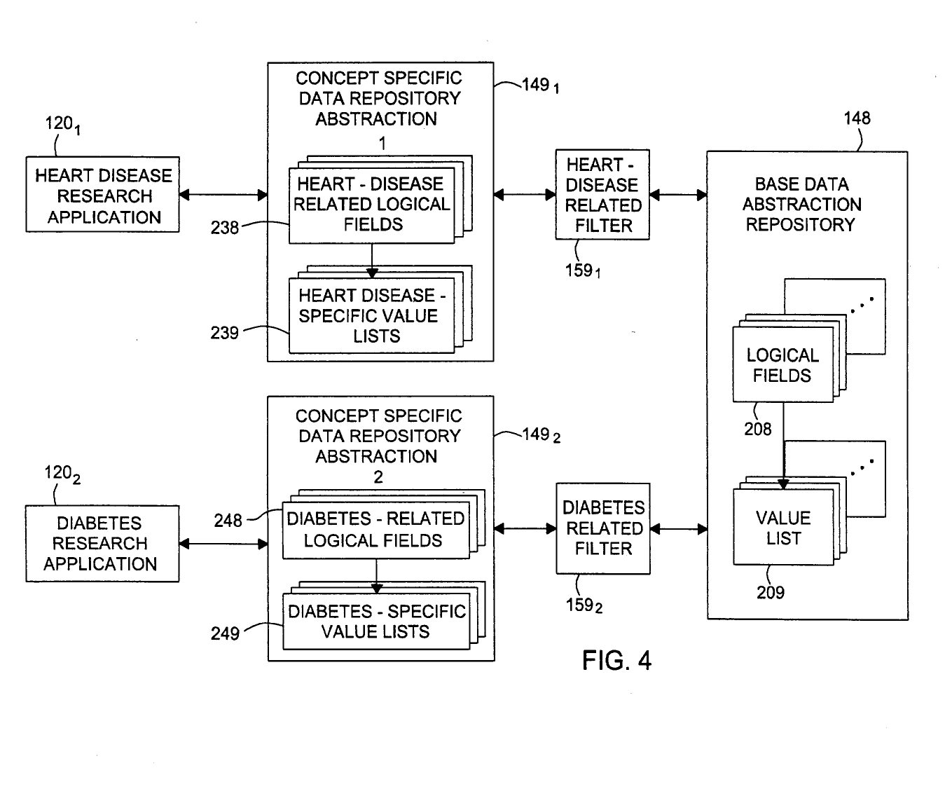

As shown in FIG. 4, multiple concept-specific DRA components 149, conceptually scoped to different concepts may be generated by applying conceptual filtering, based on different sets of specified concepts, to the same base DRA component 148. For example, a first conceptual filter 159₁ may be applied to the DRA component 148 to generate a first concept-specific DRA component 149₁ containing a first subset of fields 238 and associated values 239 (selected from fields 208 and associated values 209 of base DRA component 148) related to heart disease. In a similar manner, a second conceptual filter 158₂ may be applied to the DRA component 148 to generate a second concept-specific DRA component 149₁ containing a second subset of fields 248 and associated values 249 related to diabetes.

As illustrated, the first concept-specific DRA component 149₁ may be accessed by an application 120 120₁ used for heart disease research, while the second concept-specific DRA component 149₂ may be accessed by an application 120₂ used for diabetes research. Thus, each concept-specific DRA component 149, in effect, provides each application with a separate database, custom tailored to its specific needs. In other words, each DRA component 149 may presenting to users a subset of fields and associated values related to concepts of interest to the users, thus greatly simplifying the query building process. For example, a medical researcher may only be presented with diagnostic codes, lab tests, physician notes, reports and other data associated with specified concepts related to their field of research.

The impact, from a user's perspective, of limiting logical entities to only those related to concepts of interest (e.g., “conceptual filtering”) is illustrated in FIGS. 5A-5E, which illustrate exemplary GUI screens 510-530 for building a query, based on fields from the DRA component 148, without and with concept-specific limiting, respectively. The GUI screens 510-530 may be GUI screens, for example, of the query building interface 122. Of course, the GUI screens 510-530 are illustrate only and many different variations of suitable GUI screens may allow a user to build a concept-specific query within the scope of the present invention. Further, while the GUI screens 510-530 will be described with reference to building queries against a database containing fields related to the medical industry, similar GUI screens may be created for building queries against databases containing fields related to any industry.

FIG. 5A illustrates the query building GUI screen 510 without conceptual filtering applied, as indicated by the absence of specified concepts in a Conceptual Context window 518 that lists specified concepts. As illustrated, a Fields window 512 listing available fields (to be specified in query conditions or included as query results) may include several categories, each with various numbers of fields. However, many of the fields, and even entire categories, may not be of interest to a user. For example, the user may be a medical researcher interested only in building queries related to tumor research for specific age groups.

In a real-world medical research environment, the fields may number in the hundreds or even thousands, requiring a user to scroll/page through many screens of fields to build a query. Further, the available values associated for many of the fields may also be numerous, compounding the problem. For example, as illustrated a diagnostic category of fields may be presented, allowing the user to specify government mandated ICD-9 diagnostic codes. As illustrated in the exemplary GUI screen 520 of FIG. 5B, ICD-9 codes may also number in the hundreds or thousands, while the researcher of the present example, may only be interested in ICD-9 codes related to tumors.

Therefore, in an effort to simplify the query building process, the user may wish to apply conceptual filtering to limit the number of fields and associated values presented in the GUI screens. For example, the user may choose to specify one or more concepts of interest via the GUI screen 530 shown in FIG. 5B (e.g., accessible via an Edit Concepts button 519 shown below the Conceptual Context window 518 of the GUI screen 510). As illustrated, the GUI screen 530 may allow the user to select from a list of concepts 532 and selected concepts may be listed in a Specified Concepts window 534. As illustrated, related concepts may be automatically inserted for some concepts (e.g., Neoplasm for Tumor), which may increase the likelihood a user is presented with all fields of interest. For some embodiments, a user may be able to enable/disable the automatic inclusion related concepts.

FIG. 5D illustrates the query building GUI screen 510 with conceptual filtering applied. As illustrated, the specified concepts (Age, Tumor, and Neoplasm) are listed in the Conceptual Context window 518, and considerably fewer fields and categories (i.e., only those related to the specified concepts) are presented in the Fields window 512. In the illustrated example, Birth Date and Age fields are related to the Age concept, while Alkaline Phosphatate Test Results may be related to tumors. Further, as illustrated in FIG. 5E, when specifying a query condition based on a selected field (e.g., ICD-9 codes), a user may also be presented with considerably fewer fields. For example, as shown, the GUI screen 520 presents the user a list of only those ICD-9 codes related to tumors and neoplasm.

### CONCLUSION

A base data model may contain a vast number of fields and associated values, only a small fraction of which may be of interest to any particular user. However, through the user of conceptual filtering, a user may be presented with a limited subset of fields and associated values, chosen from the base data model, that relate to one or more specified concepts of interest to the user. By limiting the fields and associated values to those related to specified concepts of interest, the query building process may be greatly simplified.

While the foregoing is directed to embodiments of the present invention, other and further embodiments of the invention may be devised without departing from the basic scope thereof, and the scope thereof is determined by the claims that follow.

What is claimed is:

1. A method of providing access to data stored in a plurality of physical fields of a data repository, comprising:
receiving a list of one or more concepts specified by a user;
providing an interface allowing the user to build a database query based on a plurality of fields presented to the user; and
limiting the fields presented to the user in the interface to those related to the one or more user-specified concepts.

2. The method of claim 1, wherein the interface allows the user to specify query conditions based on one or more values associated with the fields.

3. The method of claim 2, further comprising limiting values presented to the user in the interface to those related to the one or more user-specified concepts.

4. The method of claim 1, wherein limiting fields presented to the user in the interface to those related to the one or more user-specified concepts comprises text searching of field names for specified conceptual terms.

5. The method of claim 4, wherein limiting fields presented to the user in the interface to those related to the one or more user-specified concepts further comprises text searching of field names for terms related to the specified conceptual terms, as indicated in a repository of related terms.

6. The method of claim 1, wherein limiting fields presented to the user in the interface to those related to the one or more user-specified concepts comprises examining an attribute of the field indicative of one or more concepts to which the field relates.

7. A computer implemented method for generating a concept-specific data repository abstraction component describing, and used to access, data in a data repository, comprising:
selecting, from a base data repository abstraction component containing logical fields mapped to corresponding physical fields of the data repository, a subset of the logical fields contained in the base data repository abstraction component related to a specified one or more concepts; and
generating a first concept-specific data repository abstraction component containing the subset of the logical fields related to the one or more concepts.

8. The computer implemented method of claim 7, wherein selecting the subset of the logical fields related to the one or more concepts comprises applying a concept-specific filter to the base data repository abstraction component.

9. The method of claim 7, further comprising generating a second concept-specific data repository abstraction component by selecting a different subset of the logical fields contained in the base data repository abstraction component related to a second list of one or more specified concepts.

10. The method of claim 7, further comprising:
selecting one or more values associated with the subset of logical fields and related to the one or more specified concepts; and
including the one or more values associated with the subset of logical fields and related to the one or more specified concepts in the first concept-specific data abstraction component.

11. The method of claim 7, further comprising:
supplementing the list of one or more specified concepts with one or more related concepts based on a repository of related terms;
selecting one or more logical fields from the base data repository abstraction related to the one or more related concepts; and
including the one or more logical fields related to the one or more related concepts in the first concept-specific data abstraction component.

12. A computer readable medium containing a program which, when executed, performs operations for generating a concept-specific data repository abstraction component describing, and used to access, data in a data repository, the operations comprising:
receiving, from a user, a list of one or more specified concepts;
selecting, from a base data repository abstraction component containing logical fields mapped to corresponding physical fields of the data repository, a subset of the logical fields contained in the base data repository abstraction component related to the one or more concepts; and
generating a first concept-specific data repository abstraction component containing the subset of the logical fields related to the one or more concepts.

13. The computer readable medium of claim 12, further comprising providing the user with a an interface allowing the user to build a database query based on a plurality of fields contained in the concept-specific data repository abstraction component.

14. The computer readable medium of claim 12, further comprising providing the user with a an interface allowing the user to specify the one or more concepts.

15. The computer readable medium of claim 14, further comprising indicating, to the user, one or more concepts related to the one or more specified concepts.

16. The computer readable medium of claim 14, further comprising selecting the one or more concepts related to the one or more specified concepts from a repository of related terms.

17. A data processing system, comprising:
a data repository;
a base data abstraction component comprising logical fields mapped to corresponding physical fields of the data repository; and
an executable component configured to generate a first concept-specific data abstraction component comprising a limited subset of the logical fields of the base data abstraction component related to a first one or more specified concepts.

18. The data processing system of claim 17, further comprising a repository of related terms used by the executable component to supplement the first one or more specified concepts with related concepts.

19. The data processing system of claim 17, wherein the executable component is configured to include in the first concept-specific data abstraction component one or more logical fields related to the related concepts.

20. The data processing system of claim 17, wherein the executable component is further configured to generate a second concept-specific data abstraction component comprising a limited subset of the logical fields of the base data abstraction component related to a second one or more specified concepts.

21. The data processing system of claim 20, further comprising:
a first application configured to generate queries based on logical fields of the first concept-specific data abstraction component; and
a second application configured to generate queries based on logical fields of the second concept-specific data abstraction component.
